(19) United States
(12) Patent Application Publication
(10) Pub. No.: US 2010/0206341 A1
(43) Pub. Date: Aug. 19, 2010

(54) AUTOMATED VEHICLE WASH SYSTEM

(75) Inventors: Ryan J. Essenburg, Holland, MI (US); Thomas J. Essenburg, Holland, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: VQ, INC., Holland, MI (US)

(21) Appl. No.: 12/388,933

(22) Filed: Feb. 19, 2009

(51) Int. Cl. B08B 3/04

(52) U.S. Cl. 134/45

(57) ABSTRACT

An automated vehicle wash system including vehicle wash equipment, a mechanical room and a control module, such as a control pod. The control pod is positioned outside the mechanical room and adjacent the vehicle was equipment so that an operator of the control pod can directly view the wash equipment as the operator adjusts controls of the control pod to precisely regulate materials, such as chemicals and other treatment liquids, delivered by the wash equipment to a vehicle as the vehicle passes along a path.

### BACKGROUND OF THE INVENTION

The present invention relates to automatic vehicle wash systems, and, more particularly, to automated vehicle wash equipment.

Most conventional car wash systems are housed in a building having an entrance and an exit. Between the entrance and exit is a wash tunnel in which a car or vehicle is washed by wash equipment. The equipment typically includes a conveyor that moves the car relative to other washing equipment at a rate for the car washing equipment to apply chemicals and water to the car. The water and chemicals usually originate and are pumped from a back room, also referred to as a “mechanical room.” The mechanical room houses basic controls for operating the equipment, such as hydraulic and power supply controls for controlling movement of the car wash equipment in the car wash tunnel, water controls for varying water pressure delivered to the wash tunnel and other valves and gauges that an operator adjusts and views to control chemicals applied to a vehicle in the wash tunnel. Due to the sensitive nature of the controls, conventional mechanical rooms are physically separated and isolated from the car wash tunnel to prevent excessive moisture, chemicals and debris from contacting the control equipment in the mechanical room.

A significant challenge to operators of conventional automated car washes is minimizing waste of chemicals while ensuring that the controls are precisely set to adequately wash a customer's car. To set up and properly configure the car wash equipment, an operator guesses the appropriate settings at which water supply controls and chemical controls can be set to deliver a predetermined amount of chemical at a specified rate. For example, to set up car wash equipment that applies a sealant to the car, the operator, who is located in the mechanical room where the controls are located, first selects an initial pressure for the water being delivered to the nozzles of the equipment, as well as a first flow rate for the sealant. The initial selection usually is a “best guess.” After the operator sets the controls, the operator exits the door of the mechanical room, and walks within view of the car wash tunnel to visually inspect a car to which sealant is applied under the first flow rate. Usually, the setting is close, but not perfect—that is, either too much or too little sealant is being applied to the car. Thus, the operator goes back into the mechanical room, resets the control to a second setting, exits the mechanical room, and revisits the car wash tunnel to re-inspect the application under the second setting. This process is iterative, and typically requires multiple trips from the mechanical room to the car wash tunnel before the setting is satisfactory.

Such a process consumes employee time and can waste a significant amount of chemicals and/or water in the process of setting the relevant controls. Moreover, this process is usually repeated whenever the supply sources of bulk chemicals change, as well as when the temperature in the car wash changes from season to season.

### SUMMARY OF THE INVENTION

The present invention provides an automated vehicle wash system including vehicle wash equipment, a mechanical room and a control module positioned outside the mechanical room and adjacent the vehicle wash equipment so that an operator of the control module can directly view the wash equipment as the operator adjusts controls to regulate materials delivered to the wash equipment.

In one embodiment, the control module can be a control pod positioned adjacent the wash equipment including one or more controls that can be adjusted by an operator as a vehicle is being washed by the wash equipment so that the vehicle is satisfactorily treated with water and/or chemicals. Optionally, the first pod can include a valve that regulates the amount of chemicals applied to an applicator in a wash tunnel through which the vehicle travels on a path. The valve can regulate the amount of chemical delivered from a chemical storage tank in the pod and/or the mechanical room to the applicator. Accordingly, the amount and rate at which the chemical applied to the vehicle can be directly and precisely controlled by the operator.

In another embodiment, the automated vehicle wash system can include a chaseway. The chaseway can provide water, hydraulic fluid, power and/or chemicals to the various vehicle wash equipment. One or more pods can be positioned along the chaseway and can include various controls that regulate the water, hydraulic fluid, power and/or chemicals communicated to the vehicle wash equipment. As one example, a pod can include a control that controls water pumps that pump, e.g., communicate water to the vehicle wash equipment. The control can be a simple valve regulating the amount of water, or a flow setting on a water pump. As another example, a pod can include a hydraulic valve bank that controls hydraulically operated components of the vehicle wash equipment, such as arms that move rotating brushes toward and away from a vehicle.

In yet another embodiment, the vehicle wash system can include a building in which the wash equipment is positioned. The building can an interior and an exterior, as well as a first wall and a second wall aligned on opposite sides of the path along which a vehicle moves while it is being washed or treated. The first and second walls can include windows so that the building has an open and airy feel. With such construction, a viewer of the building can view completely through the building while watching a vehicle being washed therein.

In yet a further embodiment, multiple pods controlling multiple materials delivered to the wash equipment and multiple aspects of the wash equipment can be provided. For example, a first pod can control the amount of chemical delivered to chemical applicator along a wash tunnel in which wash equipment is located. A second pod can regulate the amount of water pumped to applicators in the wash tunnel, as well as regulate the amount of the pressure of water administered to feed chemicals to one or more chemical applicators, e.g., arches that extend over the tunnel to spray chemicals and/or water onto a vehicle. A third pod can include a conventional hydraulic control bank that regulates the amount of hydraulic fluid, and thus movement, of rotating brushes or other moving parts of the wash equipment. Additional pods can control other aspects of the vehicle wash equipment and application of different materials to the vehicle as it travels along the path, through the wash tunnel.

The present invention provides a simple and efficient automated vehicle wash system that is easily adjusted by an operator. With a pod including controls for vehicle wash systems in plain view of the washing equipment, a user can quickly and precisely adjust the control to regulate water and/or chemicals applied by the wash equipment. Where a pod includes hydraulic, power or other controls for the vehicle wash equipment, the operator can also quickly adjust those controls while in view of the equipment in an efficient manner. This can save considerable time and resources, as well as eliminate excessive waste of material.

These and other objects, advantages and features of the invention will be more readily understood and appreciated by reference to the detailed description of the invention and the drawings.

### BRIEF DESCRIPTION OF THE DRAWINGS

FIG. 1 is plan view of a current embodiment of the automated vehicle wash system of the present invention;

FIG. 2 is a perspective view of the automated vehicle wash system with a portion of a building in which the system is housed removed;

FIG. 3 is a perspective view of a pod of the vehicle wash system;

FIG. 4 is a front view of the pod; and

FIG. 5 is a rear view of the pod with a shield panel lifted to access plumbing of the pod.

### DETAILED DESCRIPTION OF THE CURRENT EMBODIMENT

### I. Overview

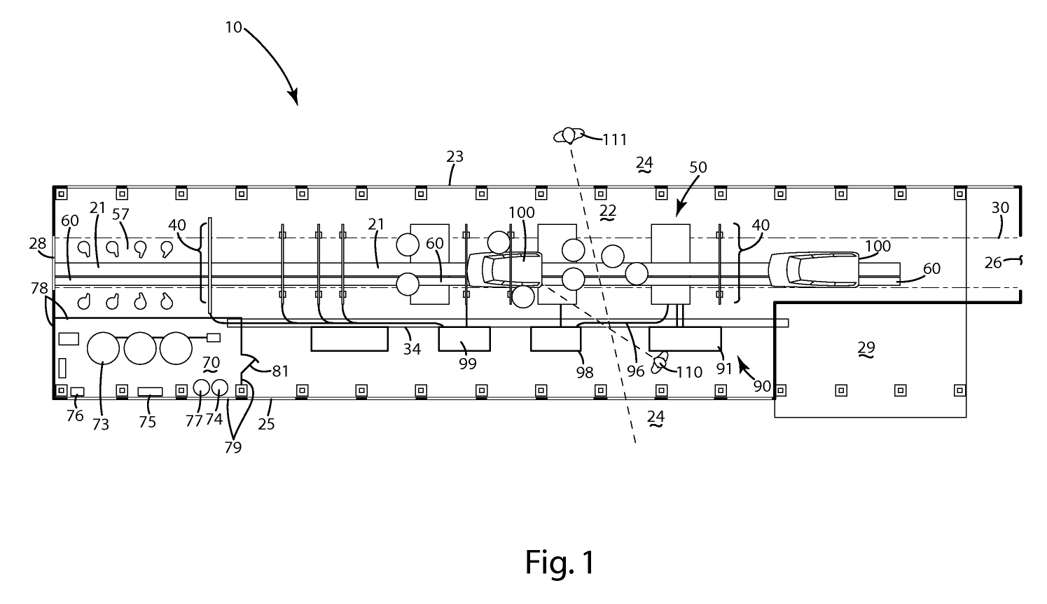

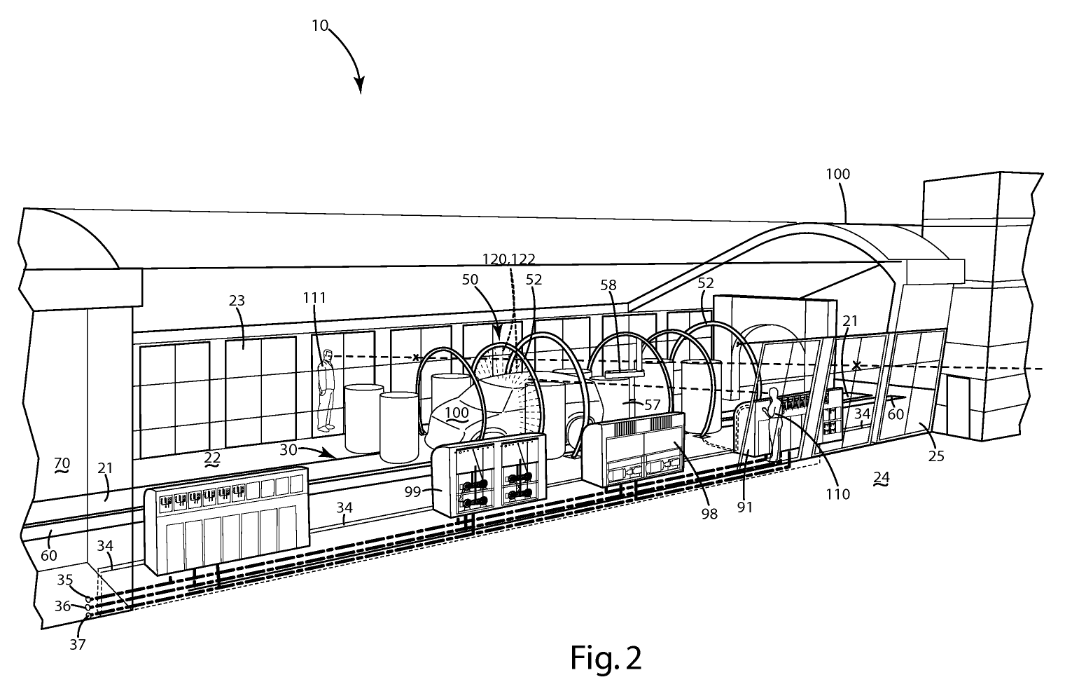

An automated vehicle wash system according to the present invention is illustrated in FIGS. 1 and 2 and generally designated 10. The automated vehicle wash system generally includes a building 20 having various wash equipment 50 that is located to apply treatments such as chemicals to a vehicle 100 as the vehicle moves along the path 30 which is generally aligned with a wash tunnel 40. A conveyor 60 can be used to move the vehicle along the path 30. The building can include within it or joined to it a mechanical room 70 in which additional equipment 73-77 is housed. The mechanical room can isolate the equipment therein from the wash tunnel 40, and the remainder of the interior of the building 20 so that moisture, debris and chemicals being dispensed in the wash tunnel 40 by the equipment 50 is prevented or impaired from contacting equipment in the mechanical room.

The building can also house pods 90 which are mounted exteriorly, or generally outside, the mechanical room 70 and adjacent the wash tunnel 40. Each pod can include controls which an operator can adjust to modify the operation of the wash equipment 50 of the wash tunnel 40. For example, a chemical applicator control pod 91 can be positioned so that an operator 110 of the pod has a generally unobstructed view of the applicator 52 and the vehicle 100. In this configuration, the operator can watch equipment and materials being applied or dispensed by the various washing equipment 50, and simultaneously can adjust that equipment and/or the rate, frequency or other feature of the application of the chemicals 120 and/or water 122.

### II. Construction and Components

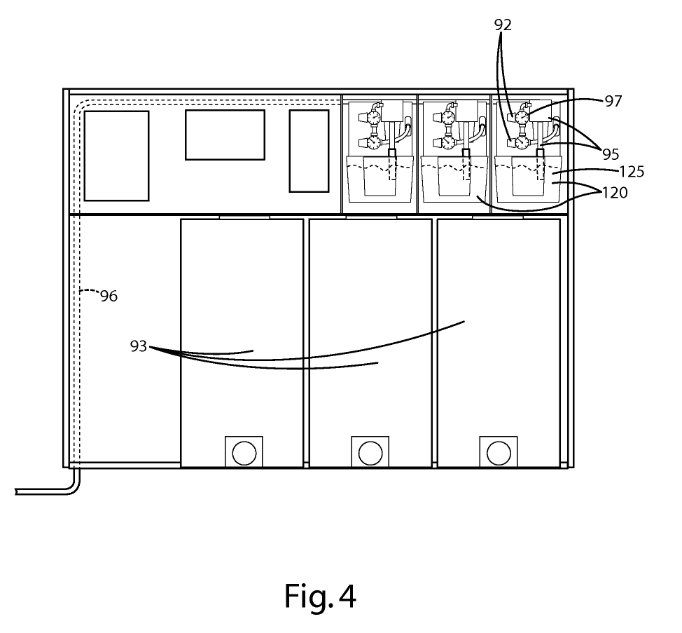

With reference to FIGS. 1-5, the various components and structure of the automated vehicle wash system 10 will be described. As shown in FIGS. 1 and 2, the building 10 is a structure including multiple walls, for example, walls 23 and 25 which are on opposite sides of the path 30. At opposite ends of the path, the building 20 can include an entrance 26 and an exit 28. The entrance and exit can be aligned so that the vehicle to be washed moves from the entrance to the exit along the path 30. Although shown as a straight line, the path can be circuitous, curved or of other configurations. The entrance and exit can optionally be configured and sized so that vehicles of a variety dimensions can pass through the entrance and exit.

Generally, the building 20 includes a interior 22 and an exterior 24. The interior 22 is the inside of the building, while the exterior is the environment surrounding the building. Although depicted as an elongate rectangular building, the building can come in a variety of shapes and configurations. In general, the building can include any type of structure or enclosure that houses all or a portion of the wash tunnel 40.

Referring to FIG. 2, the building walls 23 and 25 are aligned on opposite sides of the path. These walls can include windows 27. In general, the windows give the building an open and airy feeling to users and viewers thereof. The windows themselves can be of a variety of configurations. Optionally, the windows can be replaced with any material that is at least partially transparent or translucent.

The windows 27 can be aligned along substantial portions of the building 20 on opposing sides so that a viewer 111, when standing on one side of the building, can see completely through the building 20 from that side of the building to an opposite side of the building and beyond (FIG. 1, 2). A viewer 111 on the exterior 24 of the building 20 also can view the vehicle 100 through either the first wall 23 or the second wall 25 (and in particular, through the windows 27) as the vehicle moves from the entrance 26 to the exit 28. Of course, the view of the viewer 111 can be slightly obstructed by wash equipment 50 or other equipment within the building.

The building 20 can include interior and exterior facade which may be constructed of brick, wood, metal and/or composites. Generally, the building can include a roof which is positioned over the path 30 and other components of the building. The building 20 also can include a separate office 29 which can house or provide work stations for personnel that operate, manage or otherwise work in the building 20 in connection with the automated vehicle wash system 10. As illustrated, the office 29 is separate from the mechanical room 70, with the two usually being on opposite ends of the building. If desired, the office and the mechanical room can be combined.

As shown in FIG. 1, the automated vehicle wash system 10 can include a wash tunnel 40 positioned between the entrance 26 and the exit 28. Generally, the wash tunnel 40 is located on or adjacent the path 30 along which the vehicle 100 travels. Although described as a wash tunnel, this structure 40 need not be one configured as a conventional “tunnel” including an over-arching roof and sides. For example, the wash tunnel 40 can include equipment 50 on opposite sides of the path 30 with no roof or cover, or equipment on one side of the path 30 by which the vehicle 100 passes so that chemicals or other conventional wash treatments can be applied to the vehicle. The wash tunnel 40 can include a variety of standard vehicle wash equipment such as scrubbers, foaming brushes, water cascading arches or bars, scrubbing brushes, rotating brushes, vibrating brushes, water-spraying bars, and the like. Because these pieces of equipment are conventional, the structure and operation of this equipment will not be described.

As illustrated in FIG. 1, the car wash tunnel 40 can include multiple applicators 52 that are adapted to apply a chemical 120 and/or water 122 to a vehicle 100 on the path. The chemical can be any number of treatment materials known in the vehicle wash industry such as sealants, triple coats, soaps, surfactants, waxes, accents, and other materials in liquid, foam, gel or other forms. Further, these applicators 52 can spray, drip, brush, mist, dump, pour, or otherwise apply any of the variety of chemicals to the vehicle in concentrated form or in combination with water supplied through a pressurized water and/or chemical system joined with the applicator. An example of an applicator suitable for use in the vehicle wash system is a E-P2004 Single ring presoak arch, which is available from Tommy Car Wash Systems of Holland, Mich. An example of a scrubbing brush suitable for use in the vehicle wash system is a Model E-M2002 Wrap mitter combo, which is also available from Tommy Car Wash Systems of Holland, Mich. An example of a rotating foam brush suitable for use in the vehicle wash system is Model P-M2074 Hugger brush, which is also available from Tommy Car Wash Systems of Holland, Mich. In operation, the applicator can be adapted to apply at least one of a soap, sealant, gloss, wax and/or drying agent as desired. Generally, the wash devices 50 can be any conventional car wash device, for example, a tire gloss applicator, a final rinse arch, a hanging rinse manifold, a sealant arch, a high pressure arch, a triple coat arch, a rocker panel brush, an undercarriage wash, spray bar, a presoak module, rotating contour brushes, and the like. Optionally, the wash tunnel may or may not include a dryer station 57, which includes multiple devices that project heat and/or air against an already clean vehicle to remove water or otherwise dry the vehicle.

This equipment 50 of the wash tunnel 40 can also be referred to as wash devices. The wash devices 50 can utilize water and/or chemicals, applying them to a vehicle as it passes thereby in a conventional manner. These wash devices can be articulating, that is, they move relative to the vehicle as the vehicle approaches or passes by the wash devices. To effect movement, the wash devices can be electrically powered and/or powered by hydraulic or pneumatic structures which are conventional. For example, the rotating brush 57 can include an arm 58 which is hydraulically operated and moves the brush toward and away from the vehicle as it passes 100 along the path 30 in a conventional manner.

Adjacent or near the wash tunnel 40, the building can define a trench 21, covered with a metal grate, and adapted to collect liquids or other materials that are created during the wash process. This trench can be in communication with conventional sludge pit 5, aeration pit 5, and a clean water pit 5 (not shown) as desired. These pits can be in communication with a recycling pump (not shown) to recycle the liquids for multiple uses.

The car wash tunnel can also include a conveyor 60. The conveyor 60 can engage and move the vehicle 100 along the path 30 so that the various applicators 52 can apply materials such as chemicals 120 and/or water 122 to the vehicle 100 as the vehicle moves along the path, or more generally, so that the various wash devices 50 can engage and wash the vehicle 100. Although not shown, the conveyor can include conventional features such as correlater guide rails and a roller correlater (not shown) that move the vehicle along the path in an orderly, straight manner at the appropriate rate. One suitable conveyor is the E-C2028 Steel Conveyor, which is available from Tommy Car Wash Systems.

As illustrated in FIG. 1, the building 20 can include a mechanical room 70. This mechanical room can be positioned within the building or immediately adjacent the building 20. Optionally, the mechanical room 70 can be a completely separate structure from the building 20. The mechanical room 70 can include various equipment adapted to work in concert with the wash devices 50 in the wash tunnel 40. For example, the mechanical room 70 can include conventional car wash system equipment such as water storage tanks, which optionally can be part of a reverse osmosis system 73, an air compressor 74, a reclamation and recirculation system 75, an electric power supply 76 and/or a chemical storage tank 77. Each piece of this equipment can be in direct communication with the wash devices 50 within the wash tunnel 40 via lines, conduits, wires and the like to provide water, air, hydraulics, electrical power and/or chemicals to the wash devices.

The mechanical room can include multiple walls 78 and 79 and a door 81. The door 81 is usually closed while the wash tunnel 40 is in operation to prevent chemicals, moisture, water or other materials within the wash tunnel from substantially contacting the equipment 73-77 housed within the mechanical room 70. In some cases, these chemicals can be harsh and can impair the functionality and/or performance of the equipment. While it is the goal to prevent all moisture, water or chemicals from contacting the equipment, it is virtually impossible to do so, as sometimes the door 81 may be left open so that these materials drift into the mechanical room 70.

As shown in FIGS. 1 and 2, the vehicle wash system includes multiple pods 90 that can include controls used to adjust chemicals, water, hydraulic fluid, power, and other materials transferred or otherwise communicated to the wash devices. Optionally, those materials can be transferred to the wash devices from the mechanical room as desired. As an example, with reference to FIGS. 2-4, a first pod 91 can include one or more controls 92 which can regulate the delivery rate of (from storage tank 77 in the mechanical room and/or a storage tank 93 in the pod 91) certain chemicals to a chemical applicator 52 along the car wash tunnel 40. The pod 91 can be mounted outside of the mechanical room 70, and generally exterior to the mechanical room, so that an operator 110 positioned or standing at the pod 91 can directly view the wash devices with their own human vision (e.g., not through a closed circuit, television or video system) simultaneously as the operator 110 adjusts the control 92 to regulate chemicals that are transferred or otherwise communicated to the wash devices 50 (e.g., such as by conduits 96 that are connected to the devices and the pod 91). The operator 110 can adjust the amount of chemical delivered or otherwise adjust any one of the wash devices so that the vehicle is satisfactorily treated with the chemical and/or water that is delivered with the chemical if desired.

In general, where the pod includes chemical storage tanks 93, those storage tanks can store a predetermined volume of chemicals. For example, 10, 20, 50 to 100 gallons of chemicals such as soap, rinse material, presoak material, tire gloss, undercarriage wash materials and the like can be stored in each tank 93. The pod can also include a conventional pumping system 95 that draws the chemical from the storage tank 93 to a temporary storage container 125 through or past a control 92, such as a valve, which can be electronic or manual. The control 92 is generally in communication with a conduit 96 that leads from the first pod 91 to the applicator 52. By adjusting the control 92 and monitoring the pressure gauge 97, an operator can select a desired pressure and/or volume for transfer of the chemical to the applicator 52. Optionally, the pod can be outfitted with a touch screen or other known electronic modules to control delivery of the chemical or other materials to the various wash devices 50 from the pod 91. One type of control 92 suitable for use is the E-SE-C2028 Remote mount touch screen control, which is available from Tommy Car Wash Systems.

A variety of different pods can be included in the automated vehicle wash system. As another example, a second pod 99 can be outfitted with additional pumps, for example, 15 horsepower, 20 gallon per minute pumps to provide additional pumping capacity to pump water to the wash devices 50. These pumps are generally conventional and will not be described here. This pod can be utilized to provide high pressure washing through various arches in the wash tunnel 40 as desired. This pod may also include its own controls (such as valves and pump output controls) that enable an operator to adjust the output of water through this pod to the wash devices 50. Another pod 98 can house a hydraulic control bank which generally controls the actuation and movement of various wash devices 50, e.g., the movement of rotating brushes toward and away from a vehicle 100, along the wash tunnel. This hydraulic power unit and the bank itself is generally conventional and will not be described here.

Because the pods are mounted outside the mechanical room 70 and adjacent the wash tunnel 40, an operator can control each of the pods while the operator 110 has a generally unobstructed view of the car wash devices he is controlling on the car wash tunnel. By generally unobstructed view, it is meant that the operator can view application of the chemical and/or water or movement of a particular car wash device in an unimpaired manner with their own human vision. It will be appreciated that a slight portion of the view of materials being applied may be obstructed by a portion of a wash device, but generally, the operator can see the effect of the adjustment that he is making in the tunnel 40 by manipulating controls 92 on the pod 91.

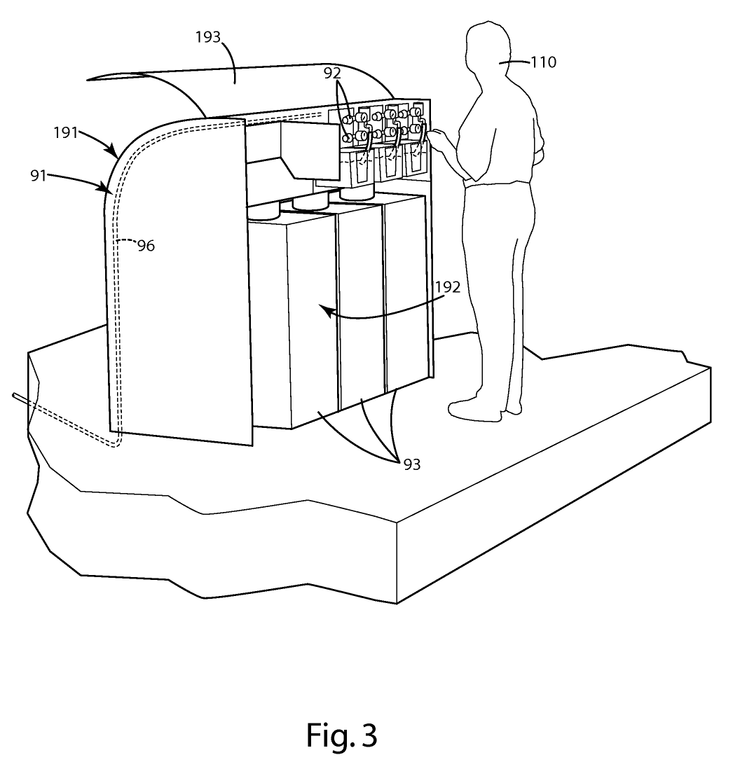

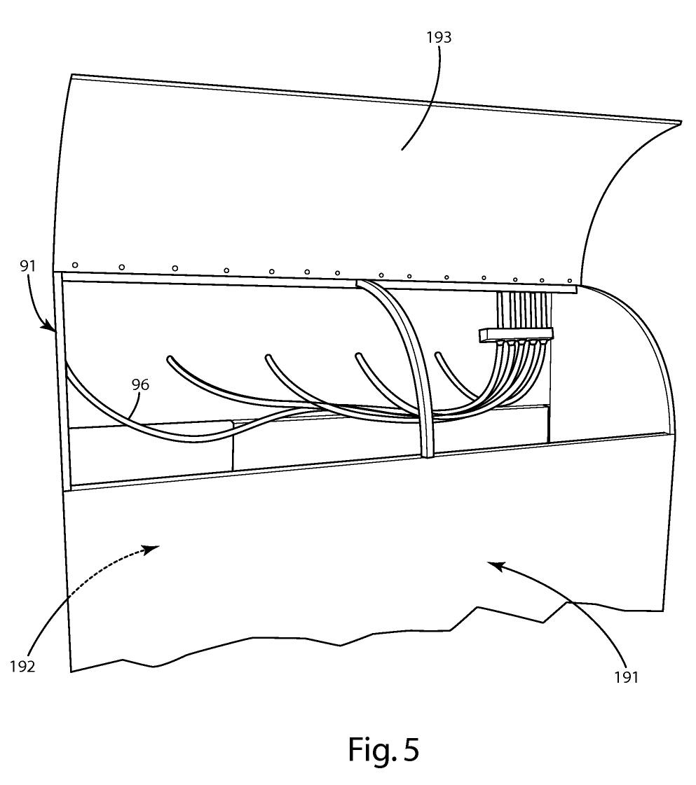

With FIGS. 3 and 5, the pods 90 can be constructed generally to include a tunnel facing side 191 and a second side 192 that faces away from the car wash tunnel. The tunnel facing side 191 can include a shield 193 that is hingedly connected to the pod. This shield 193 can generally be of an arcuate or curvilinear surface so that water easily drains off it toward the car wash tunnel or generally away from the controls 92. As shown in FIG. 5, by opening the shield 193, an operator can access plumbing of the pod 91, such as conduit 96. The shield can prevent a significant amount of chemicals and/or water from contacting the controls or otherwise depositing on the controls. The different surfaces of the pod surrounding the controls can be constructed from a durable, moisture-resistant material such as stainless steel, composite stainless steel, composites and/or combinations of these materials.

Referring to FIG. 1, the pods can be positioned along and in communication with a chaseway 34 that is defined by the building floor 29. By “in communication,” it is meant that a first piece of equipment is fluidly or electronically or otherwise coupled to a second piece of equipment for the transfer of a material, including but not limited to, water, air, electricity, hydraulic fluid and chemicals, from the first piece of equipment to the second piece of equipment. The chaseway can generally be in the form of a field trench that runs from the mechanical room 70 and past the pods 90. As shown in FIG. 2, the chaseway 34 can include a variety of different conduits and/or lines such as a hydraulic line 35, an electric line 36 and a water line 37. These lines can convey or otherwise communicate hydraulics, electricity, and/or water from the equipment in the mechanical room 70 to select ones of the pods 90. In turn, the pods, with their controls, can be used to regulate the amount of those items that are communicated to the various wash devices 50 along the wash tunnel 40. The chaseway 34 can also include a grate positioned over the various lines to protect those lines from being contacted or otherwise damaged by vehicles, cleaning equipment or personnel. As desired, the chaseway can also extend from the mechanical room 70 to the office 29 to provide electricity to and/or water to the office as desired. Further, the chemical lines 96 from the pods 90 can also extend a distance along the chaseway before branching off to the wash devices 50, e.g., an applicator 52.

As noted above, the function of the various wash devices of the wash tunnel is generally conventional and will not be explained in detail here. Suffice it to say that the various arches apply combinations of water and chemical in predetermined amounts and rates to adequately wash a vehicle 100 passing thereby. Where included, the brushes operate in a conventional manner moving toward and away from the vehicle at appropriate timed intervals guided by a control system to adequately scrub the vehicle.

The control of the various wash devices, however, is unconventional and is effected by an operator while that operator is in view of the wash devices and/or the vehicle 100 along the path 30. For example, an operator 110 stands adjacent a pod, such as, pod 91, to make an adjustment. The operator may desire to alter the amount of chemical being applied as a sealant to the vehicle 100. Accordingly, the operator 110 manipulates the controls 92 of the pod 91, while reviewing the output gauges 95 as well as viewing the applicable applicator arch 52. As the operator makes the adjustment, he can view the applicator directly with his own vision to see how the amount of sealant changes and whether any adverse effects, such as excessive foaming, etc. occurs. Based on his knowledge of the operation of the system, the operator 110 can quickly complete adjustment of the controls 92 so that the appropriate amount of chemicals 120 is drawn through from the storage tanks 93 and transferred via the conduit 96 to the applicator arch. Because the pod is exterior to the mechanical room 70 and adjacent the tunnel, the operator can make all adjustment s while simply standing at a the pod—rather than revisiting the mechanical room and wash tunnel multiple times until the desired effect is achieved.

The above descriptions are those of the preferred embodiments of the invention. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

The embodiments of the invention in which an exclusive property or privilege is claimed are defined as follows:

1. An automated vehicle wash system comprising:
a building including an interior and an exterior, the building defining an entrance and an exit, the entrance and exit aligned so that a vehicle to be washed moves from the entrance to the exit along a path, the building including a first wall and a second wall aligned on opposite sides of the path, the opposing walls including portions that are at least partially transparent so that a viewer on the exterior of the building can view the vehicle through either the first wall or the second wall as the vehicle moves from the entrance to the exit along the path;
a wash tunnel positioned between the entrance and the exit along the path, the wash tunnel including an applicator adapted to apply a chemical to the vehicle on the path;
a conveyor that engages and moves the vehicle along the path so that the applicator can apply the chemical to the vehicle as the vehicle moves along the path;
a mechanical room at least one of joined with and positioned in the building, the mechanical room including equipment in communication with the applicator, the mechanical room isolating the equipment from the wash tunnel so that at least one of moisture and the chemical is at least impaired from substantially contacting the equipment; and
a pod mounted outside the mechanical room and adjacent the wash tunnel, the pod including a control that is adapted to adjust application of the chemical by the applicator, the pod being positioned so that an operator of the pod has a generally unobstructed view of the applicator and the vehicle, so that the operator can view the application of the chemical by the applicator to the vehicle and simultaneously adjust the application of the chemical to the vehicle.

2. The vehicle wash system of claim 1 wherein the portions that are at least partially transparent are a plurality of windows, and wherein a viewer can view completely through the building from one side of the building to an opposite side of the building.

3. The vehicle wash system of claim 1 wherein the applicator applies at least one of a soap, a sealant, a gloss and a drying agent.

4. The vehicle wash system of claim 2 comprising a dryer that dries the vehicle between said vehicle wash tunnel and said exit.

5. The vehicle wash system of claim 3 wherein the building includes a floor, wherein the floor defines a chaseway, wherein at least one of a hydraulic line, an electric line and a water line are positioned in the chaseway and extend between the mechanical room and the pod, whereby the at least one of a hydraulic line, the electric line and the water line are protected from being damaged.

6. The vehicle wash system of claim 5 wherein the mechanical room equipment includes at least one of a water storage tank, an air compressor, a hydraulic pump, an electrical power supply, and a chemical storage tank.

7. A vehicle wash system comprising:
a building defining an entrance and an exit between which a path extends,
an applicator adapted to apply at least one of water and a chemical to a vehicle on the path;
a mechanical room at least one of joined with and positioned in the building, the mechanical room including equipment that supplies at least one of water and the chemical to the applicator, the mechanical room isolating the equipment from the wash tunnel so that at least one of water and the chemical is at least impaired from substantially contacting the equipment; and
a first pod mounted outside the mechanical room and adjacent the path, the first pod including a manual control that is adapted to adjust application of the at least one of water and the chemical by the applicator, the first pod being located so that an operator of the first pod is positioned outside the mechanical room when engaging the manual control,
wherein the operator has a generally unobstructed view of the applicator and the vehicle when engaging the first pod, whereby the operator can view the application of the at least one of water and the chemical by the applicator and simultaneously, adjusts the application of the at least one of water and the chemical so that the at least one of water and the chemical are applied in an appropriate manner.

8. The vehicle wash system of claim 7 wherein the first pod includes a chemical storage tank that stores the chemical and a conduit leading from the first pod to the applicator.

9. The vehicle wash system of claim 8 wherein the control is a valve in communication with the conduit, the valve being actuatable to regulate the amount of chemical that travels through the conduit.

10. The vehicle wash system of claim 7 wherein the building includes an office remote from the first pod and the mechanical room.

11. The vehicle wash system of claim 7 comprising a chaseway extending from the mechanical room to the first pod.

12. The vehicle wash system of claim 7 comprising a second pod including a second control, the second pod positioned adjacent and in view of the path, the second pod being distal from the first pod, the second pod being located so that an operator of the second pod is positioned outside the mechanical room when engaging the second pod.

13. The vehicle wash system of claim 12 comprising a second applicator adapted to apply a second chemical to the vehicle, the second applicator being at least partially controlled by the second control, wherein the operator has a generally unobstructed view of the second applicator and the vehicle when the operator engages the second control to adjust the second applicator.

14. A vehicle wash system comprising:
a vehicle wash tunnel including a plurality of wash devices that cooperate to treat a vehicle with at least one of water and a chemical;
a mechanical room positioned adjacent the vehicle wash tunnel, the mechanical room housing equipment that is in communication with at least one of the plurality of wash devices, the mechanical room including a shielding wall that shields the equipment from the at least one of water and the chemical;
a chaseway communicating at least one of water, hydraulic fluid, power and the chemical to the plurality of wash devices; and
a first pod positioned along the chaseway and including a first control that regulates the at least one of water, hydraulic fluid, power and chemical communicated to the plurality of wash devices, the first pod being positioned entirely outside the mechanical room and adjacent the plurality of wash devices,
wherein an operator of the first pod positioned adjacent the first pod can directly view the wash devices with their own vision simultaneously as the operator adjusts the first control to regulate the at least one of water, hydraulic fluid, power and chemical communicated to the plurality of wash devices, whereby the operator can adjust the plurality of wash devices so that the vehicle is satisfactorily treated with the at least one of water and the chemical.

15. The vehicle wash system of claim 14 wherein the first control regulates the water communicated to at least one of the plurality of wash devices.

16. The vehicle wash system of claim 15 comprising a second pod positioned along the chaseway and including a second control that regulates the chemical communicated to at least one of the plurality of wash devices, the second pod being positioned entirely outside the mechanical room and adjacent the plurality of wash devices, wherein an operator of the second pod positioned adjacent the second pod can directly view the wash devices with their own vision simultaneously as the operator adjusts the second control to regulate the chemical communicated to the at least one of the plurality of wash devices,

17. The vehicle wash system of claim 14 comprising a building that houses the vehicle wash tunnel, the mechanical room, the chaseway and the first pod.

18. The vehicle wash system of claim 17 wherein the building includes a first wall and a second wall aligned on opposite sides of the vehicle wash tunnel, the first and second walls including windows that enable a viewer on the exterior of the building to view the vehicle through either the first wall or the second wall.

19. The vehicle wash system of claim 14 wherein the first pod includes a shield that is interposed between the vehicle wash tunnel and the first control to at least partially shield the control from the at least one of water and the chemical.

20. The vehicle wash system of claim 14 wherein the first pod includes a chemical storage tank.
